(19) United States
(12) Patent Application Publication
(10) Pub. No.: US 2006/0124535 A1
(43) Pub. Date: Jun. 15, 2006

(54) Water filtration system for high flow rate water tub circulation system

(76) Inventor: Keith W. Harbol, Oceanside, CA (US)

Correspondence Address: SNELL & WILMER LLP, 600 ANTON BOULEVARD, SUITE 1400, COSTA MESA, CA, 92626, US

(21) Appl. No.: 11/008,840

(22) Filed: Dec. 10, 2004

(51) Int. Cl. B01D 25/00

(52) U.S. Cl. 210/460; 210/167; 210/416.1

(57) ABSTRACT

A water tub includes a circulation system utilizing a high permeability type (HPT) filter to filter water being pumped to form water jets. In some instances, HPT filters are used to filter all of the water circulated through a water tub, including water being utilized in therapeutic water jets. In some instances the described water tubs have a flow rate to filter material ratio greater than 1.

### FIELD OF THE INVENTION

The present invention relates generally to water treatment systems, and more particularly to water treatment systems for water tubs used by people for soaking and/or bathing such as spas, hot tubs, and whirlpool baths.

### BACKGROUND OF THE INVENTION

Water tubs are frequently used for recreational and/or therapeutic purposes. However, repeated and/or long term use tends to have a negative impact on water quality when water within such tubs is not replaced. As replacement of water in a water tub between uses is generally not convenient or cost effective, it is desirable to provide means for maintaining and/or improving water quality. Moreover, the benefits provided by a water tub are often enhanced by directing one or more streams/jets of water into the tub to massage someone sitting in the tub by impacting against them. Such streams/jets are sometimes referred to as “massaging jets”, or in some instances, simply “jets”. As such, water tubs are frequently coupled to water circulation and/or filtration system.

As used herein, a water tub is any apparatus comprising a cavity sized and dimensioned to permit a person to submerge all or at least part of his/her body within water held in a cavity of the water tub. As such, a water tub may be, but is not necessarily limited to, a spa, hot tub, or whirlpool bath. Such a water tub frequently has one or more water circulation and/or filtering systems to maintain water temperature and/or quality. In many instances, such a tub will also include one or more outlets used to direct a stream/jet of water into the cavity in a direction likely to impact a person seated or standing within the cavity, or having a limb positioned within the cavity, particularly if the cavity contains the number of people it is adapted to hold. In some instances the cavity may be sized and dimensioned to allow one or more people to sit within the cavity and be submerged to chest or shoulder height. In other instances, the cavity may be sized and dimensioned to only permit a limb of a person to be submerged such as with a whirlpool bath sized for soaking a person's foot, ankle, and calf. As used herein, water tubs generally do not include tanks or other containers that are not adapted for human use in that they are not easily entered and exited by a person or animal, are overly large or to small for bathing and/or soaking, and/or comprise systems for creating or maintaining conditions not suitable for bathing and/or soaking such as extreme temperatures or maintaining a cavity filled with chemicals not suitable for a person or animal to bathe or soak in. Examples of various water tubs, water tub support systems, and related methods can be found by referring to U.S. patents referencing one or more of classes D23/277, 4/488, 4/538, and/or any related subclasses. It should be noted that such patents are not necessarily prior art, and referencing them herein is not an assertion or admission that they are prior art.

Although prior water tubs are known, there is a need for novel water tubs at least in part because previously known water tubs, support systems, and related methods do not provide a balance between features such as reduced cost and increased maintainability, operability, and portability that is suitable in all instances.

### SUMMARY OF THE INVENTION

One embodiment of the present invention is a water tub including a circulation system having at least one jet pump that is high capacity water pump having a GPM rating of at least 120 GPM, at least one high permeability type (HPT) filter, and at least one feed line establishing one or more flow paths between the HPT filter and the jet pump. Another embodiment of the present invention is a water tub with a circulation system having a flow rate to filter material ratio that is greater than 1. Yet another embodiment of the present invention is a method of water filtration for a water tub comprising using at least one HPT filter to filter at least some of the water circulated through the system.

### BRIEF DESCRIPTION OF THE DRAWINGS

The exact nature of this invention, as well as the objects and advantages thereof, will become readily apparent from consideration of the following specification in conjunction with the accompanying drawings in which like reference numerals designate like parts throughout the figures thereof and wherein:

FIG. 1 is schematic of a circulation system for a water tub in accordance with an exemplary embodiment of the invention.

FIG. 2 is schematic of an alternate circulation system for water tub in accordance with an exemplary embodiment of the invention.

FIG. 3 is schematic of yet another alternate circulation system for water tub in accordance with an exemplary embodiment of the invention.

FIG. 4 is a top view of a high permeability type filter used in an exemplary embodiment of the invention.

FIG. 5 is a cross-sectional side view of the filter of FIG. 4.

FIG. 6 is a perspective view of the filter of FIG. 4.

### DETAILED DESCRIPTION OF THE PREFERRED EMBODIMENTS

Reference will now be made to the preferred embodiments of the invention, examples of which are illustrated in the accompanying drawings. While the invention will be described in conjunction with the preferred embodiments, it will be understood that these embodiments are not intended to limit the invention. On the contrary, the invention is intended to cover alternatives, modifications and equivalents, which may be included within the spirit and scope of the invention as defined by the appended claims. In the following detailed description, numerous specific details are set forth in order to provide a thorough understanding of the present invention. However, it will be understood by one of ordinary skill in the art that the present invention may be practiced without these specific details. In other instances, well known methods, procedures, components, and circuits have not been described in detail so as not to unnecessarily obscure the important aspects of the present invention.

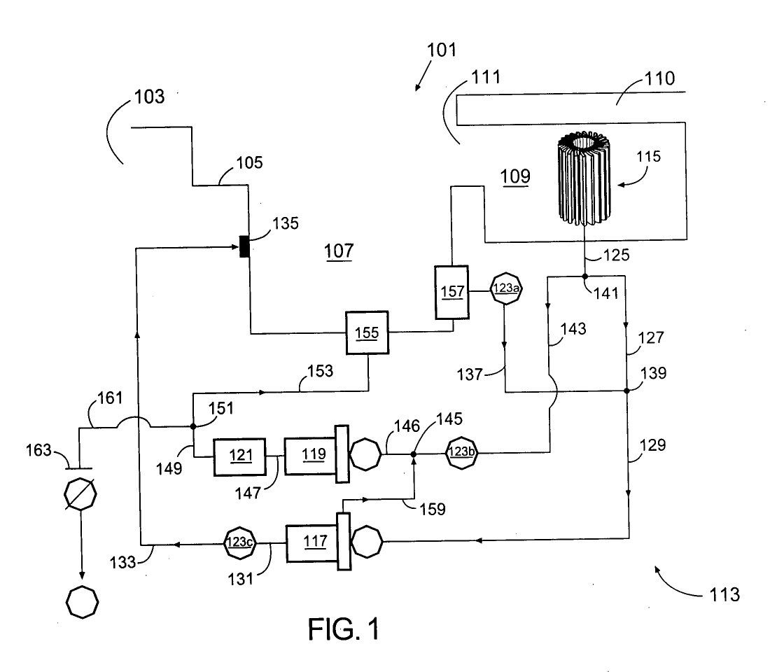

In FIG. 1, a water tub 101 is shown schematically as having a body 103 with a seat/step 105, a seating cavity 107, a skimmer cavity 109, a skimmer cavity cover 110, and a circulation system 113. During use, the seating cavity 107 of water tub 101 is filled with water to a height sufficient to allow water to flow between seating cavity 107 and skimmer cavity 109 via orifice 111. The circulation system 113 has a filter 115, a jet pump 117, a circulation pump 119, a heater 121, a primary drain and heater return orifice 155, a drain valve 163, an unfiltered water inlet 157, a jet outlet 135, and check valves 123 (123A, 123B, and 123C). Water flows into system 113 from the skimmer cavity 109 through the filter 115, and from the seating cavity 107 through the unfiltered water inlet 157. Flow of water through the system 113 is controlled by the check valves 123 and the pumps 117 and 119. The arrowed lines represent flow paths between elements, and comprise ridged and flexible PVC lines (pipes, hoses, etc.). As shown, the lines include filter feed line 125, filter jet line segments 127 and 129, jet return line 133, filter circulation line segments 143 and 146, cross-over line 159, circulation-heater line 147, heater return line segments 149 and 153, drain line 161, and unfiltered feed line 137. Line 125, and segments 143 and 127 are connected via junction 141. Line 137 and segments 127 and 129 are connected via junction 139. Line 159 and segments 143 and 146 are connected by junction 145. Line 161 and segments 149 and 153 are connected by junction 151. The check valve 123A allows water to flow into system 113 through unfiltered water inlet 157 during operation of jet pump 117. Check valve 123B prevents water from line 159 from flowing toward filter 115. Check valve 123C prevents water from flowing in from jet outlet 135 and backwards through pump 117.

During operation, water is drawn through filter 115 by either the jet pump 117 or the circulation pump 119. If jet pump 117 is operating, the check valve 123A allows water to flow into system 113 through unfiltered water inlet 157 as well as through filter 115 to prevent filter 115 from limiting the flow of water through jet pump 117. As such inlet 154, check valve 123, and line 137 operate to bypass filter 115 during jet pump operation. When jet pump 117 is not operating, circulation pump 119 is used to maintain water quality and temperature by causing water to flow through filter 115 and heater 121.

Jet pump 117 is a high capacity pump having a GPM rating of at least 120 GPM and preferably about 170 GPM, but is operated to maintain a flow rate of between 100 and 170 GPM, typically an average of 120 GPM. Jet pump 117 functions to cause water with inductive air to jet out of jet outlet 135 and to massage a person positioned in seating cavity 107. In alternative embodiments, jet pump 117 may comprise a plurality of pumps operating serially and/or in parallel.

Circulation pump 119 has a lower GPM rating, about 7 GPM, than jet pump 117, is operated to maintain a flow rate of between 3 and 7 GPM and on average 5 GPM, and causes water to flow through filter 115 and heater 121 at least when jet pump 117 is not operating. Pump 119 sucks water from the skimmer cavity in through filter 115, line 125, and line 143, and/or lines 127, 129, and 159.

Valve 163 is used to control whether water drains out of water tub 101 via primary drain 155, line 153, junction 151, and line 161.

The filter 115 is preferably a high permeability type (HPT) filter, formed from a polyethylene material having 90-150 micron pores. The filter 115 may or may not include a center core, and may have one or more ends capped with a polymeric material. A method of making a material suitable for use in filter 115 is described in U.S. Pat. No. 6,030,558, herein incorporated by reference in its entirety. Using such a method, a filter material may be formed by forming pellets of thermoplastic polymer material by rapid water quenched palletizing, and sintering the pellets into a porous material.

In alternative embodiments, any of the elements of water tub 101 may be replaced by a different number of similar elements or one or more other devices providing the function of any replaced element. As such, among other possible variations, a plurality of filters may be used in place of filter 115, a plurality of jet pumps for jet pump 117, a plurality of inlets for inlet 157 and a priority of outlets for outlet 135. In some embodiments, one or more elements of water tub 101 may not be included such as an embodiment that utilizes a two speed jet pump and no continuous circulation pump.

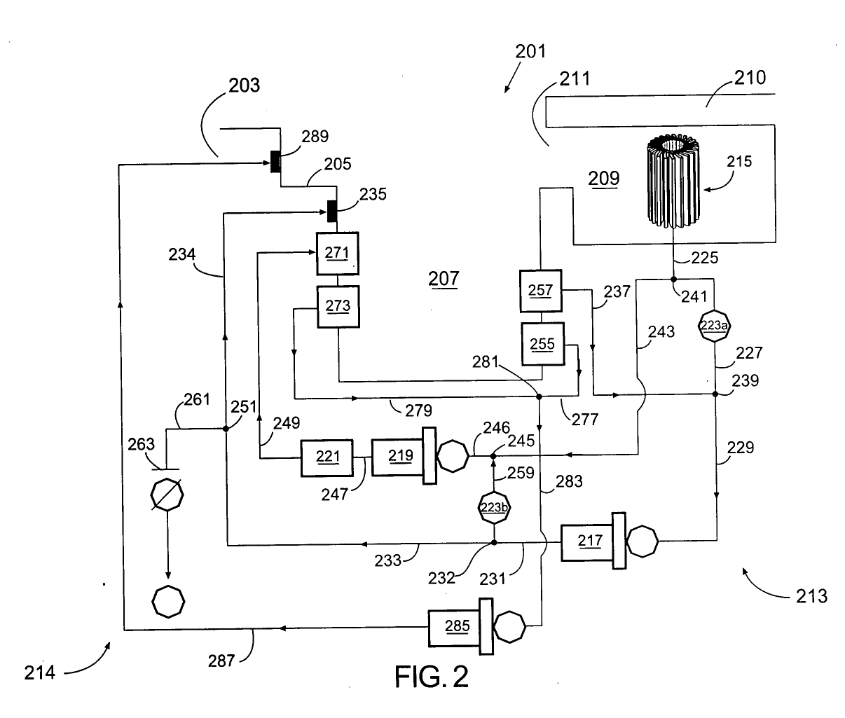

In FIG. 2, a water tub 201 is shown schematically as having a body 203 with a seat/step 205, a seating cavity 207, a skimmer cavity 209, a skimmer cavity cover 210, and circulation systems 213 and 214. During use, the seating cavity 207 of the water tub 201 is filled with water to a height sufficient to allow water to flow between the seating cavity 207 and the skimmer cavity 209 via a connecting orifice 211.

The circulation system 213 comprises a filter 215, a jet pump 217, a circulation pump 219, a heater 221, a heater return orifice 271, a drain valve 263, unfiltered water inlets 257, a jet outlet 235, and check valves 223 (223A and 223B). Water flows into the system 213 from the skimmer cavity 209 through the filter 215, and from the seating cavity 107 through the unfiltered water inlet 257. Flow of water through the system 213 is controlled by the check valves 223 and the pumps 217 and 219. The arrowed lines represent flow paths between elements, and comprise ridged and flexible PVC lines (pipes, hoses, etc.). As shown, the lines include a filter feed line 225, filter jet line segments 227 and 229, jet return line segments 231, 233, and 234, filter circulation line segments 243 and 246, a cross-over line 259, a circulation-heater line 247, a heater return line 249, a drain line 261, and an unfiltered feed line 237. The line 225 and the segments 243 and 227 are connected via a junction 241. The line 237 and the segments 227 and 229 are connected via a junction 239. The line 259 and the segments 243 and 246 are connected by a junction 245. The line 261 and the segments 233 and 234 are connected by a junction 251. The check valve 223A allows water to flow into the jet pump portion of the system 213 through the segment 227. The check valve 223B allows water to be forced into the circulation pump 219 through the line 259, the junction 245, and the line 246, when the jet pump 217 is activated.

In the circulation system 214, water entering the system via the inlets 273 and 255 is pumped by pump 285 through the outlet 289 into the seating cavity 207. The system 214 includes lines 277, 279, 283, and 287, and a junction 281. The circulation system 214 is independent of the circulation system 213 as there aren't any flow paths (excluding the seating cavity) allowing water to cross between the systems 213 and 214.

Systems 213 and 113 differ primarily in regard to the use and placement of the check valves (123 and 223) and the lines (159 and 259) crossing between the jet pump portions and circulation pump portions of the systems.

The filter 215 is preferably, as is the filter 115, a high permeability type (HPT) filter, and is formed from a polyethylene material having 90-150 micron pores. The filter 215 may or may not include a center core, and may have one or more ends capped with a polymeric material.

As with the water tub 101, in alternative embodiments, any of the elements of the water tub 201 may be replaced by a different number of similar elements or one or more other devices providing the function of any replaced element.

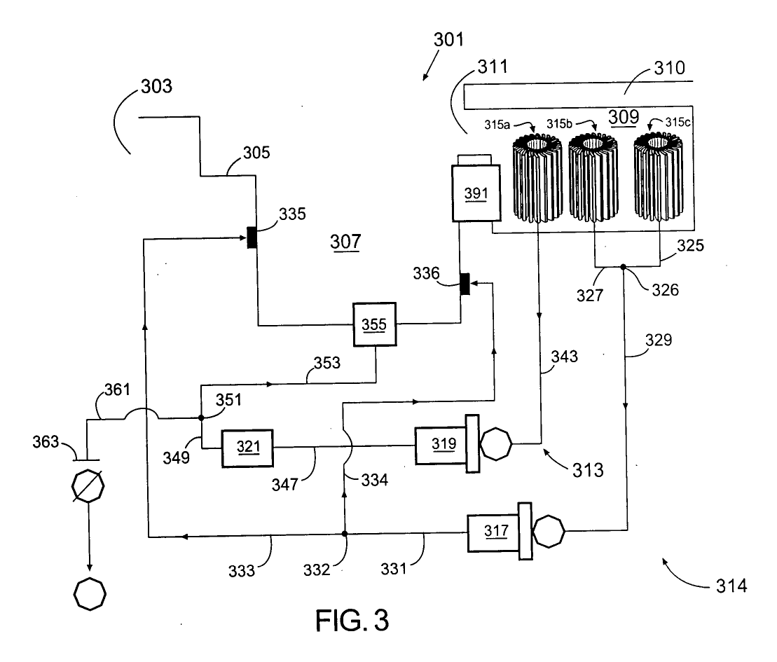

In FIG. 3, a water tub 301 is shown schematically as having a body 303 with a seat/step 305, a seating cavity 307, a skimmer cavity 309, a skimmer cavity cover 310, an equalizer/suction fitting 391, and circulation systems 313 and 314. During use, the seating cavity 307 of the water tub 301 is filled with water to height sufficient to allow water to flow between the seating cavity 307 and the skimmer cavity 309 via a connecting orifice 311. The circulation systems 313 comprises a filter 315A, a circulation pump 319, a heater 321, a primary drain and heater return orifice 355, and a drain valve 363.

The circulation systems 313 comprises a filter 315A, a circulation pump 319, a heater 321, a primary drain and heater return orifice 355, and a drain valve 363. Water flows into the system 313 from the skimmer cavity 309 through the filter 315A, and water flow is controlled by the pump 319. The arrowed lines represent flow paths between elements, and comprise ridged and flexible PVC lines (pipes, hoses, etc.). As shown, the lines include a filter a feed line 343, a circulation-heater line 347, heater return line segments 349 and 453, and a drain line 361. The drain line 361 and the segments 349 and 353 are connected by a junction 351.

The circulation system 314 comprises filters 315B and 315C, a jet pump 317, and jet outlets 335 and 336. Water flows into the system 314 from the skimmer cavity 309 through the filters 315B and 315C, and water flow is controlled by the pump 317. The arrowed lines represent flow paths between elements, and comprise ridged and flexible PVC lines (pipes, hoses, etc.). As shown, the lines include filter feed lines 325, 327, and 329, and jet return lines 331, 333, and 334. The lines 325, 237, and 329 are connected by a junction 326, and the lines 331, 333, and 334 by a junction 332.

The filters 315 are, as are filters 115 and 215, preferably high permeability type (HPT) filters, and are formed from a polyethylene material having 90-150 micron pores. The filters 315 may or may not include a center core, and may have one or more ends capped with a polymeric material.

As with the water tubs 101 and 201, in alternative embodiments, any of the elements of water tub 301 may be replaced by a different number of similar elements or one or more other devices providing the function of any replaced element or elements.

The water tub 303 differs from that the water tub 101 primarily in that it has a system (313) for heating water that is independent of the system (314) for feeding the water jets. As such, there is no need for check valves as the pumps 317 and 319 are sufficient for controlling water flow through the systems 313 and 314. The tub 303 also differs from the tub 101 in that only filtered water can enter the systems 313 and 314. Another difference is that all the water pumped by the jet pump 317 is pulled from the skimmer cavity 309. A suction fitting 391 is provided to insure that there is always sufficient water in the cavity 309 to satisfy the input needs of systems 313 and 314.

The tub 301 with the systems 313 and 314 differs from the tubs 101 and 201 with the systems 113 and 213 in that the tub 301 does not incorporate a by-pass system of the jet pump(s). All of the water in the body 307 is filtered by the filters 315A-C on every cycle through a circulation system, regardless of whether it enters the circulation system 313 or the circulation system 314.

It is contemplated that the water tubs described herein benefit from the use of the HPT filters (115, 215, and 315) in that the total square footage of filter material can be reduced, and it becomes possible to filter all circulated water rather than just a fraction of the filtered water regardless of the number and capacity of pumps used. In preferred embodiments, the filters 115, 215, and 315 each comprise less than 10 square feet of filter material, more preferably comprise less than 8 or even less than 7 square feet of filter material, and preferably comprise about 6.5 square feet of filter material.

In some instances, water tubs may be compared by comparing their respective total flow rate to total square footage of filter material ratios (hereinafter “flow rate to filter material ratio”). A tub which varies the number of pumps and/or filters used during operation may have different ratios at different times. For such tubs the flow rate to filter material ratio (the FRFMR) will be the highest of those ratios. Determining the FRFMR for a given operating state simply requires dividing the total flow rate by the total square footage of filter material. The total square footage of filter material is determined by adding up the square footage of each filter in use for a given operating state. As an example, if two filters having 6.5 square feet of filter material are in use, the total square footage of filter material is 13. The total flow rate is determined by adding up the flow rates that the pumps pulling water through the active filters are operating at. Also, if the flow rate varies during a particular operating state, the flow rate used will be the average flow rate. As an example, if a single pump is being operated at an average flow rate of 120 GPM, then the total flow rate is 120 GPM even if the pump's capacity is significantly higher or lower. Using the example numbers, the ratio is then 120/13 or approximately 9.2.

Referring to FIG. 3, the tub 301 potentially has at least 3 FRFMRs. A first if the system 313 is operated independently, a second if the system 314 is operated independently, and a third if the systems 313 and 314 are operated simultaneously. The number of FRFMRs would increase if the pumps 317 and 319 were operated at different speeds during different operating states. Assuming for the sake of this example that: (a) the pumps 317 and 319 operate at a single speed and are either on or off, (b) the pump 317 has an average GPM during operation of 120 GPM, and the pump 319 has an average flow rate during operation of 5 GPM; and that (c) the filters 315a, 315b, and 315c each have 6.5 square feet of filter material, then the three ratios would be 5/6.5, 120/13, and 125/19.5, i.e. 0.76, 9.2, and 6.4. For this example, the FRFMR for the tub 301 would be 9.2 as it is the highest of the three ratios. If the pumps 317 and 319 had lower flow rates during other operating states, the FRFMR of the tub would remain the same as 9.2 would still be the highest ratio.

It is contemplated that it is advantageous to have the FRFMR for a tub be greater than 1, greater than or equal to 5, and/or greater than or equal to 9. The tubs described herein have such FRFMRs.

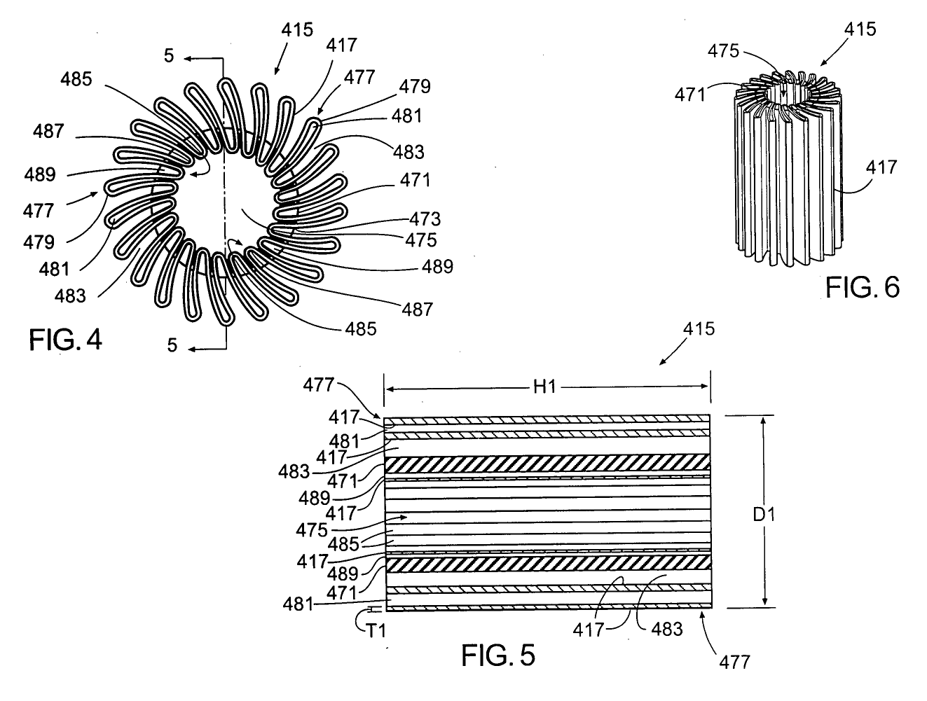

Higher FRFMRs can be obtained at least in part through the use of HPT filters. FIGS. 4-6 show a preferred HPT filter 415 suitable for use as the filter 115 of FIG. 1, the filter 215 of FIG. 2, and the filters 315a, 315b, and 315c of FIG. 3. As shown, the filter 415 includes a tube 471, and a polyethylene filter material 417 having several external pleats 477 and internal pleats 485 extending from openings 473 of the tube 471. The tube 471 also has a center cavity 475. Each external pleat 477 has an outside end/bend 479 and a cavity 481, and each internal pleat 485 has an inside end/bend 487 and a cavity 489. The external pleats 477 are separated by spaces 483. The filter 415 preferably has one end capped, and the other end coupled to a stand pipe that is part of a line such as lines 125, 225, 325, 327, and 343 of FIG. 1-3. Water flows through the filter material 417 into the center cavity 475 and then into the standpipe to which the filter 415 is coupled. Water is prevented from flowing into the center cavity 475 through the ends of the center cavity 475 because one end is capped and the other is coupled to a stand pipe.

The dimensions, materials, and components of any HPT filters used will likely vary between embodiments. However, it is contemplated that it is advantageous to utilize an HPT filter having a height H1 of about 10.0 inches, a diameter D1 of about 6.0 inches, and a filter wall thickness T1 of about 0.1 inches, and a tube diameter of about 2.4 inches. It is also contemplated in some instances the square footage of filtration material 417 will be about 4.5 sq. ft. or about 4.75 sq. ft., and that the filtration material 417 will have 120-140 micron pores and be formed from a polyethylene material.

It is contemplated that the apparatus and methods disclosed herein may be used in combination with one or more features of previously or subsequently known water tubs, water tub support systems, and/or related methods.

The present invention may take a variety of embodiments. One embodiment of the invention is a water tub including a circulation system comprising at least one jet pump that is high capacity water pump having a GPM rating of at least 120 GPM, at least one high permeability type (HPT) filter; and at least one feed line establishing one or more flow paths between the at least one HPT filter and the at least one jet pump. The invention might be characterized as comprising or satisfying one or more of the following elements and/or recitations: (a) the at least one HPT filter has a pore size of about 90 microns to about 150 microns; (b) the at least one HPT filter comprise less than 10 feet of filter material; (c) the at least one jet pump is operated to cause water to flow into a seating cavity at a rate of about 5 GPM to about 10 GPM; (d) the circulation system is configured such that substantially all the water pumped by the at least one jet pump passes through the at least one HPT filter; (e) the tub comprises a skimmer cavity and substantially all the water pumped by the at least one jet pump is obtained from the skimmer cavity; (f) substantially all the water pumped by a heater and a pump circulation systems is obtained from the skimmer cavity; (g) the at least one jet pump is part of the jet pump circulation system, and the heater circulation system comprises a pump having a GPM rating lower than the GPM rating of the at least one jet pump; (h) the at least one HPT filter is a cartridge positioned fit on the end of a standpipe such that water entering the standpipe passes through the at least one HPT; and (i) at least one HPT filter comprises a material produced by forming pellets of thermoplastic polymer material by rapid water quenched palletizing, and sintering the pellets into a porous material.

Another embodiment of the invention is a method of water tub water filtration comprising using at least one HPT filter to filter at least some of the water circulated through the system. In this or other instances, the invention may might be characterized as comprising or satisfying one or more of the following elements and/or recitations: (a) the at least one HPT filter is used to filter substantially all the water circulated through the system; (b) at least some of the water circulated through the system is pumped by a first pump that is high capacity water pump having a GPM rating of at least 120 GPM; (c) at least some of the water circulated through the system is pumped by a second pump that has a lower GPM rating than the first pump, and water pumped by the second pump flows through a heater; (d) the at least one HPT filter has a pore size of about 90 microns to about 150 microns; (e) the at least one HPT filter comprise about 6.5 square feet of filter material; and (f) the first pump is operated to cause water to flow into a seating cavity through a plurality of jets at at a rate of about 5 GPM to about 10 GPM per jet.

Yet another embodiment of the invention is a water tub having a flow rate to filter material ratio that is greater than 1, greater than or equal to 5, and/or greater than or equal to 9.

What is claimed is:

1. A water tub circulation system causing water to flow through a water jet, the water tub circulation system comprising:
a high permeability type filter positioned in the circulation system to filter water before it passes through the water jet.

2. A water tub including a water circulation system comprising:
at least one jet pump that is high capacity water pump having a GPM rating of at least 120 GPM;
at least one high permeability type (HPT) filter; and
at least one feed line establishing one or more water flow paths between the at least one HPT filter and the at least one jet pump.

3. The water tub of claim 2 wherein the at least one HPT filter has a pore size of about 90 microns to about 150 microns.

4. The water tub of claim 3 wherein the at least one HPT filter comprises less than 10 square feet of filter material.

5. The water tub of claim 4 wherein the at least one HPT filter comprises about 6.5 square feet of filter material, and the at least one jet pump as a GPM rating of about 170 GPM.

6. The water tub of claim 5 wherein the circulation system is configured such that substantially all the water pumped by the at least one jet pump passes through the at least one HPT filter.

7. The water tub of claim 6 wherein the tub comprises a skimmer cavity and substantially all the water pumped by the at least one jet pump is obtained from the skimmer cavity.

8. The water tub of claim 2 wherein:
the water tub comprises a skimmer cavity;
the water tub comprises both a heater circulation system and a jet pump circulation system;
both the heater and jet pump circulations systems comprise at least one HPT filter positioned within the skimmer cavity; and
substantially all the water pumped by the heater and jet pump circulation systems is obtained from the skimmer cavity.

9. The water tub of claim 8 wherein:
the at least one jet pump is part of the jet pump circulation system; and
the heater circulation system comprises a pump having a GPM rating lower than the GPM rating of the at least one jet pump.

10. The water tub of claim 2 wherein the at least one HPT filter is a cartridge positioned on the end of a standpipe such that water entering the standpipe passes through the at least one HPT.

11. The water tub of claim 2 wherein the at least one HPT filter comprises a material produced by forming pellets of thermoplastic polymer material by rapid water quenched palletizing, and sintering the pellets into a porous material.

12. A method of water tub water filtration comprising using at least one HPT filter to filter at least some of the water circulated through a water circulation system.

13. The method of claim 12 wherein the at least one HPT filter is used to filter substantially all the water circulated through the system.

14. The method of claim 13 wherein the at least one HPT filter is used to filter substantially all the water circulated within the water tub.

15. The method of claim 14 wherein at least some of the water circulated through the system is pumped by a first pump that is high capacity water pump having a GPM rating of about 170 GPM, and each of the at least one HPT filters comprises about 6.5 square feet of filter material.

16. A water tub comprising:
at least one filter and at least one flow path between the filter and a pump wherein water flows through the filter, flow path, and pump during a particular operating state; and
the flow rate to filter material ratio of the at least one filter and at least one flow path during that operating state is greater than 1.

17. The tub of claim 16 wherein the ratio is greater than or equal to 5.

18. The tub of claim 17 wherein the ratio is greater than or equal to 9.
